(19) United States
(12) Patent Application Publication
(10) Pub. No.: US 2002/0133504 A1
(43) Pub. Date: Sep. 19, 2002

(54) Integrating heterogeneous data and tools

(76) Inventors: Harry Vlahos, Belmont, CA (US); Clay M. Kasow, Palo Alto, CA (US)

Correspondence Address: JOHN C. PHILLIPS, Fish & Richardson P.C., Suite 500, 4350 La Jolla Village Drive, San Diego, CA, 92122, US

(21) Appl. No.: 10/001,226

(22) Filed: Oct. 29, 2001

Related U.S. Application Data
(60) Provisional application No. 60/244,108, filed on Oct. 27, 2000.

(51) Int. Cl. G06F 17/00

(52) U.S. Cl. 707/104.1

(57) ABSTRACT

A distributed data processing system may include an interface that receives a data processing request from a requesting entity, a processing server to provide access to local data processing applications, a shadow processing server to provide access to remote data processing applications, and an application server to fulfill the received data processing request by selectively accessing local and remote data processing applications transparently to the requesting entity. Access to data may be facilitated by providing heterogeneous data sources with software wrappers that provide an object representation of the data source, providing outputs of software wrappers to a first accumulator that aggregates data to generate a first aggregate data representation, and using a second accumulator to generate a second aggregate data representation based on the first aggregate data representation from the first accumulator. The software wrappers may hide details (e.g., format, location) of the data source.

### RELATED APPLICATION

This application claims the benefit of U.S. Provisional Patent Application No. 60/244,108, filed Oct. 27, 2000.

### TECHNICAL FIELD

The systems and techniques described below relate to the field of informatics, particularly the integration of heterogeneous data sources, analysis tools and/or visualization tools.

### BACKGROUND

Informatics is the study and application of computer and statistical techniques to the management of information. For example, bioinformatics includes the development of methods to search biological databases quickly and analyze biological information. The need for efficient searching and analytical tools is highlighted by the ongoing data explosion in scientific fields that has created a vast amount of data requiring storage and subsequent analysis by the scientific community. As an illustration of how rapidly data has accumulated, GenBank, a major repository of DNA sequence data, included about five million individual sequence records, or four billion base pairs, in mid-2000; by comparison, in 1995, GenBank included only half a million individual sequence records, representing less than half a billion base pairs.

The current preference for viewing and manipulating data is in a desk-top computer environment. This is a convenient approach since computer networks allow access to programs and data sources located on other computers. However, although data and programs are theoretically accessible, this does not mean that researchers are currently able to use the data and programs in an efficient and meaningful manner.

To investigate an area of interest thoroughly, researchers generally want a global, integrated view of the available data relating to their topic that allows them to analyze that data using any number or type of software analysis tools. Data can be found in a wide variety of forms and locations, ranging from flat files on private computer systems, to public or private databases, to Web pages either on the Internet or on an intranet.

Similarly, the tools used to analyze data often can be found in different of locations, for example, on different networks or computer systems, and often run on different platforms. A tool generally requires input data in a particular input format and generally produces data in a particular output format. Therefore, even though a vast quantity of data may be available, the various formats that the data is stored in and the limitations of the analytical tools may make meaningful acquisition, integration, and analysis of the data difficult if not impossible.

Questions of location and format are not the only problems facing researchers. The data pool is constantly growing. Therefore, researchers need to have a research tool that can cope with a rapidly expanding data pool. While data is widely available, the sheer volume of data that must be assessed can lead to “data overload” for many scientists who must comb through a vast amount of data before they can find information of interest to them.

Another problem facing researchers is that even if data from various sources were integrated, ideally it would need to be normalized. Some information could be repeated, some data would not be reliable as other data, and some sources may use different terminology to refer to the same concept. This can compromise the usefulness of the data.

There are two common approaches to integrating data, i.e., combining data, from heterogeneous sources. The first is to build a centralized data warehouse. This requires data cleansing, data association, and a periodic population (i.e., update) of the repository so it can be accessed consistently by all applications. This approach provides a consistent format of data, which benefits applications that access the warehouse. However, while this approach works well when data is relatively static and the data types are relatively non-diverse, scientific data tends to be dynamic and to be stored in diverse locations. In order to keep track of this data, the warehouse would have to updated frequently. This can be very labor intensive and impractical.

The second common approach to data integration is writing separate point-to-point connections to each data source. An advantage of this approach is that data is accessed in real time though the point-to-point connection so the latest version of the data is being used. However, this approach does not truly integrate data. Rather, point-to-point connections provide direct access to data; another application would be required to integrate the data gathered over the point-to-point connections. Additionally, the point-to-point approach may be considerably slower than the data warehouse approach because the speed of each data source may differ. In addition, applications built to analyze data gathered using point-to-point connections still must manage a variety of data formats. Using this method, therefore, typically requires that applications be rewritten every time a data source changes its data formats.

There are two common solutions to the data analysis problem. The first is to use a standard tool and write data converters for each input format. Inputs are converted prior to each analysis run. An advantage of this approach is that it allows the user to use “best-of-class” tools while using a scripting language to automate the tasks. However, this approach does not work well when the tool is not local, e.g., is located on a remote Web site, because using a remote tool in concert with other tools, which may be local or remote or both, poses implementation and operational difficulties.

Another solution to the data analysis problem is to use an enterprise software suite that contains pre-built analysis components that have been designed to work together. However, the tools are limited to those provided by the software suite and typically cannot easily be extended or modified. Therefore, the latest, or most appropriate or useful, tools may not be incorporated in the software suite. If the user needs to use tools that have not been included in the suite, these tools may need to be integrated into the suite.

Because of the problems with the solutions listed above, as new data, tools, and analysis algorithms are produced by the scientific community, the integration of these within an organization can prove to be very expensive, in terms of acquisition cost and time spent integrating these items.

The prior art contains several responses to some of these problems.

U.S. Pat. No. 6,125,383 discloses a research system that employs Java™ and Common Object Request Broker Architecture (CORBA) technology in order to integrate biological and/or chemical data with individual analysis tools resident on a local server.

U.S. Pat. No. 5,970,490 discloses a method for processing information contained in heterogeneous databases used for design and engineering by using an interoperability assistant module that transforms data into a common intermediate representation of the data, then generates an “information bridge” to provide target data. This patent also discloses how to standardize terminology in extracted data.

U.S. Pat. No. 6,102,969 discloses a “netbot” that intelligently finds the most relevant network resources (i.e., Web sites) based on a request from a user. The user may then select which sites to visit. This patent discloses file wrapper technology.

Lion Bioscience AG's SRS is a text indexing system. File-based databases are copied locally and indexed. SRS then provides a search interface to access the data. It does not support data contained in relational databases and cannot search data contained in web sites or proprietary data feeds.

IBM's Garlic technology is a middleware system that employs data wrappers to encapsulate data sources. These data wrappers mediate between the middleware and the data sources. After receiving a search request, the query execution engine works with the wrappers to determine the best search scheme across all the data sources for the data sources as a whole, not each individual data source. The wrapper may execute the query using Structured Query Language (SQL) statements. The Garlic technology is incorporated into IBM's biosciences software package Discovery Link.

### SUMMARY

The systems and techniques described here may provide tools useful for the integration and analysis of data from disparate, heterogeneous sources and formats. One implementation includes a platform in which integrated data is normalized, duplicate data entries are erased, and consistent tenninology is used to describe the data. The platform can be written entirely in a Java programming language and environment and may be compatible with a wide variety of standards, including Java 2 Enterprise Edition (J2EE), Java Server Pages (JSP), Servlets, Extensible Markup Language (XML), Secure Socket Layer (SSL), Enterprise Java Beans (EJB), Remote Method Invocation—Internet Inter-ORB Protocol (RMI-IIOP) servers, and/or Oracle DBMS. The systems and techniques described here leverage the robustness and acceptance of these technologies to deliver solutions that can scale across the entire enterprise.

In one implementation, an information server combines data from heterogeneous sources. The information server serves as middleware between applications and analysis modules, and the data sources. Each data source is associated with a data wrapper that publishes virtual tables of the information in the data source. An advantage of using a wrapper is that the data remains in the original location and the data source's native processing capabilities may be used to access the information. The wrapper may cache data that does not change very frequently to speed up subsequent queries.

The information server may include an accumulator that aggregates, normalizes and de-duplicates data from related data sources into a single universal data representation (“UDR”) (see U.S. patent application Ser. No. 09/196,878, incorporated herein by reference) that can subsequently be queried and analyzed by applications. The accumulator de-duplicates data by removing duplicate or redundant data, normalizes data by applying algorithms to normalize the data against known reference values, and by applying domain-specific ontology to normalize the vocabulary across various data sources.

In one implementation, a query is performed first and then the results of the query are normalized and de-duplicated. The wrappers can remap the query into native queries against the data sources, yielding very detailed results.

Accumulators may be layered to yield object representations of a combination of data sources. Over time, this layering creates data repositories, which offer a researcher an opportunity to query over repositories for several domains.

The processing server, which may be thought of as an analysis engine, may use a wrapper to wrap the “best” (e.g., the most appropriate for the context) of the available analysis tools into a single processing environment. These tools can be wrapped regardless of whether they are proprietary or in the public domain. The wrapper translates the data (e.g., now in UDR format) into any input format required by the various analysis tools. The tools may be located on the same machine as the processing server, in different hardware and software environments, or may be distributed over a network such as the Internet. The processing server's tool wrappers hide details, such as input and output formats, platform and location of each tool, and parameters required to run the tool, from the user and provide a consistent view of the tools to the user. Results of the analysis may be saved to the information server.

Applications may benefit from the processing server in many ways—the abstraction of the data access, the abstraction of the analysis execution, the transparency of the analysis location (local and remote tools), and/or the unified access of both data and results.

A prioritization engine may prioritize information delivery to individual users. A profile may be created and information may be filtered according to the user's interests. The profile may be created in one of two ways: either the user may explicitly note his or her fields of interest or the system may track the queries that the user is performing, the information most frequently accessed, and the applications most frequently used. Creation of this profile may prevent information overload to the user.

A visualization server, which is a specialized version of the processing server, provides a visualization framework by incorporating a variety of viewers, visualizers, and data mining tools. Each of these visualization tools has a wrapper that abstracts the tools to form a visualization framework that allows the user to view the outputs of queries or the results of analyses.

Various implementations may provide one or more of the following advantages. A query across multiple, heterogeneous data sources can be processed to produce transformed, normalized data that is optimized for each data source and that takes advantage of the data source's native processing capabilities to improve the results of the search. Both public and proprietary data stored in various locations and in different formats can be integrated, including relational databases, flat files, and Web (World Wide Web) and FTP (File Transfer Protocol) sites, in local and remote locations.

Heterogeneous data sources at different locations and in different formats can be searched and the results from the search can be integrated into a universal data representation. A query can be performed across several heterogeneous data sources with the query being optimized for each data source.

A single processing environment can be created that enables the analysis of data using disparate software analysis tools, regardless of whether the tools are stored in different locations and/or require different input and output formats. A visualization framework can be created with which to view all the results of queries or analyses received from disparate data sources and tools.

Information delivered to users can be personalized and filtered, thereby avoiding information overload.

Queries or analysis requests can be distributed transparently to multiple nodes for efficient execution of the requests.

A complete history of every result in the system can be maintained as an audit trail, and the audit trail can be an analysis pipeline for high throughput repetitive analysis.

A self-healing process can be implemented to provide timely distribution of software component updates and timely notification to personnel of need for updates.

Additional data sources can be incorporated into an existing system with little or no changes to the system. A system can be expanded quickly by adding additional servers for increased capacity and additional nodes for multiple sites. A system can be configured so that public data is maintained externally and proprietary data is maintained behind a firewall.

The various components described here may simplify application development and maintenance, and streamline the user's activities through an application. By hiding low-level details of the information access, the application may use the data in an effective way, without having to worry about or compensate for the interface and access mechanisms native to each data source. By hiding low-level analysis tool nuances, the application need only deal with results of the analysis, not how the analysis can be performed, or what platform is required for each analysis tool. By hiding the interfaces to various visualization tools, the applications can be extended at any time to incorporate richer views of the information without the need to change each application to take advantage of the new visualization methods.

Implementations may include various combinations of the following features.

Access to data may be facilitated by providing each of a plurality of heterogeneous data sources with an associated software wrapper that provides an object representation of data in the data source, providing outputs of one or more software wrappers to a first software accumulator that aggregates data from data sources to generate a first aggregate data representation, and using at least a second software accumulator to generate a second aggregate data representation different from the first aggregate data representation based at least in part on the first aggregate data representation from the first software accumulator. At least one of the software wrappers may hide one or more details (e.g., format, location) of the data source.

The second aggregate data representation may be generated using the first aggregate data representation from the first software accumulator and data from one or more software wrappers. The software wrapper used to generate the second aggregate data representation also may be used to generate first aggregate data representation. Alternatively, the software wrapper used to generate the second aggregate data representation may be different from the one or more software wrappers used to generate first aggregate data representation. The second aggregate data representation may be generated using the first aggregate data representation from the first software accumulator and data from at least a third software accumulator.

Virtually any arbitrary number of software accumulators may be interconnected to generate a corresponding number of aggregate data representations. In general, the aggregate data representations may be used as building blocks to generate additional aggregate data representations as desired.

Generating a universal data representation may involve normalizing the first or the second aggregate data representations.

Information from one or more data sources may be cached at the software wrapper level or at the software accumulator level, or a combination of the two.

Managing access to a data source may be implemented by encapsulating a data source in a software wrapper configured to accommodate one or more parameters of the data source and to provide an object representation of data in the data source, detecting that one or more parameters of the data source have changed, and automatically downloading from a remote source a replacement software wrapper configured to accommodate the changed one or more parameters of the data source. The replacement software wrapper may be installed while the original software wrapper is executing. The one or more parameters of the data source may relate to one or more of a format or a location of data in data source.

The remote source may be implemented as a self-healing manager component executing on a remote platform. The self-healing manager may perform operations such as determining whether a replacement software wrapper exists, and if so, providing the replacement software wrapper to a requesting entity. Or, if not, notifying a support site that a replacement software wrapper has been requested.

Detecting that one or more parameters of the data source have changed may involve identifying a change in the data that the software wrapper is unable to accommodate. Upon detecting that one or more parameters of the data source have changed, the software wrapper may cease to provide data. After installing the automatically downloaded software wrapper, providing data from the software wrapper may be resumed without having to restart an application associated with the software data wrapper.

Automatically downloading a replacement software wrapper from a remote source may involve sending an error manager to a remote self-healing manager component. In addition, automatically downloading a replacement software wrapper from a remote source may involve periodically polling a remote process until a replacement software wrapper is available.

Managing access to a data source may be implemented by encapsulating each of a plurality of data sources in an associated software wrapper configured to provide an object representation of data from the data source, providing outputs of the software wrappers to a software accumulator that aggregates data to generate an aggregate data representation;

detecting that one or more data parameters have changed, and automatically downloading from a remote source a replacement software accumulator configured to accommodate the changed one or more data parameters. The replacement software accumulator may be installed while the original software accumulator is executing. The remote source may include a self-healing manager component executing on a remote platform and which performs operation including determining whether a replacement software accumulator exists, and if so, providing the replacement software accumulator to a requesting entity. Or, if not, notifying a support site that a replacement software accumulator has been requested.

Upon detecting that one or more data parameters have changed, the software accumulator may cease to provide data. Upon installing the automatically downloaded software accumulator, providing data from the software accumulator may resume. Automatically downloading a replacement software accumulator from a remote source may involve periodically polling a remote process until a replacement software accumulator is available.

A distributed data processing system may include an interface configured to receive a data processing request from a requesting entity, a processing server configured to provide access to one or more local data processing applications, one or more shadow processing servers, each shadow processing server configured to provide access to one or more remote data processing applications, and an application server, in communication with the processing server and the shadow processing server, and configured to fulfill the received data processing request by selectively accessing local and remote data processing applications in a manner that is transparent to the requesting entity. The interface configured to receive a data processing request from a requesting entity may be a web server. Each shadow processing server may have a communications link for communicating with an interface at a remote data processing system. The shadow processing server may communicate with a servlet executing in a web server at the remote data processing system. Each shadow processing server may have an associated configuration file that identifies one or more remote data processing applications.

A distributed data acquisition system may include an interface configured to receive a data acquisition request from a requesting entity, an information server configured to provide access to one or more local data sources, one or more shadow information servers, each shadow information server configured to provide access to one or more remote data sources, and an application server, in communication with the information server and the shadow information server, and configured to fulfill the received data acquisition request by selectively accessing local and remote data sources in a manner that is transparent to the requesting entity.

A distributed data acquisition and processing system may include an interface configured to receive an information request from a requesting entity, a processing server configured to provide access to one or more local data processing applications, one or more shadow processing servers, each shadow processing server configured to provide access to one or more remote data processing applications, an information server configured to provide access to one or more local data sources, one or more shadow information servers, each shadow information server configured to provide access to one or more remote data sources, and an application server, in communication with the processing server, the shadow processing server, the information server, and the shadow information server, and configured to fulfill the received information request by selectively accessing local and remote data sources and local and remote data processing applications in a manner that is transparent to the requesting entity.

Heterogeneous data sources may be managed by a) querying a plurality of heterogeneous data sources, b) creating an object representation of each queried data source, c) normalizing data in the object representations to provide a semantically consistent view of the data in the queried data sources, and d) aggregating the object representations into a universal data representation. Each data source may have an associated software wrapper configured to (i) create an object representation of the data, (ii) transform a language of the query into a native language of the data source, (iii) construct a database for caching information contained in the data source, (iv) cache the information contained in the data source in the database automatically; (v) perform self-tests to ensure the wrapper is operating correctly, (vi) provide notification upon detecting an error, and (vii) download and install updates automatically when an error is detected. Normalizing data may involve performing data normalization or vocabulary normalization or both. Further, duplicate data may be removed. An update's authenticity may be verified prior to installation. Querying the plurality of data sources may involve submitting a query to a data integration engine that distributes the query to the plurality of data sources.

Details of one or more implementations are set forth in the accompanying drawings and the description below. Other features, objects, and advantages will be apparent from the description and drawings, and from the claims.

### DRAWING DESCRIPTIONS

FIG. 1 is a block diagram of an implementation of an informatics platform.

FIG. 2 is a block diagram of a basic system architecture that may be used for an informatics platform.

FIGS. 3a and 3b are block diagrams of an information server.

FIG. 3c is a block diagram of a process for performing a query.

FIG. 4 is a flowchart of a process for performing a query.

FIG. 5 is a block diagram of an application server, an information server, a processing server, and a visualization server.

FIG. 6 is a block diagram of a system architecture for an informatics platform.

FIG. 7 is a block diagram of an extended system architecture for an informatics platform.

FIG. 8 is a block diagram showing an example of a split node distributed over three sites.

FIG. 9 is a block diagram showing an example of layering accumulators to generate different data representations.

### DETAILED DESCRIPTION

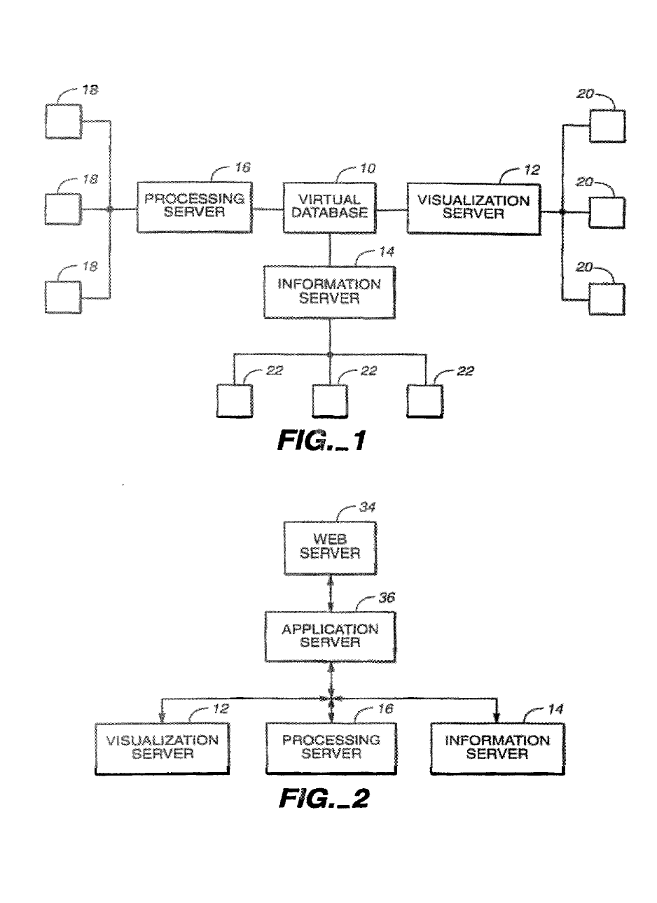

FIG. 1 shows an implementation of an informatics platform. The platform combines heterogeneous data sources 22, analysis tools 18, and visualization applications 20 in a single framework. The platform may combine these heterogeneous entities without displacing existing systems that already use the sources, tools, or applications. The platform uses middleware engines, in this example, the information server 14, the processing server 16, and the visualization server 12. The information server 14 provides a semantically consistent view of the data from several dynamic, heterogeneous data sources 22. This information is provided in the form of a virtual database 10, which can be accessed by the processing server 16 and the visualization server 12 through the information server 14. (Although FIG. 1 shows the virtual database 10 as a separate entity from the information server 14, in a typical implementation, virtual database 10 may reside within the information server 14.) The processing server 16 is able to combine various different types of analysis tools 18, including public domain tools, third party solutions, and proprietary custom-developed tools, in a single processing environment thereby providing “virtual compute services” that represent the best-of-class analysis tools. The visualization server 12 can combine a variety of viewers, visualizers, and data mining tools 20 into a visualization framework. The viewing tools 20 are abstracted by the visualization server 12 to provide datatype-specific visualization services that can be invoked by an application to view the results of queries or analyses. The platform may be made platform independent, for example, by implementing it in Java or an equivalent language.

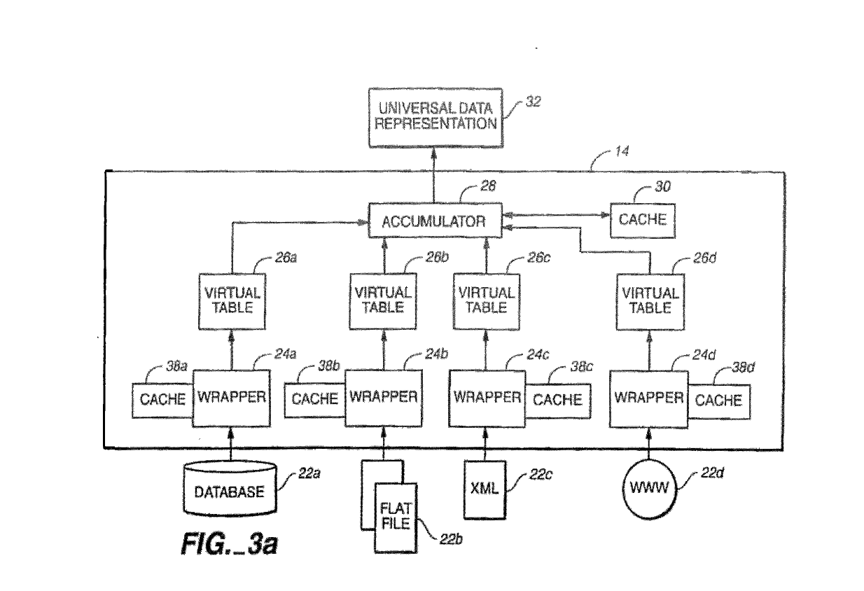

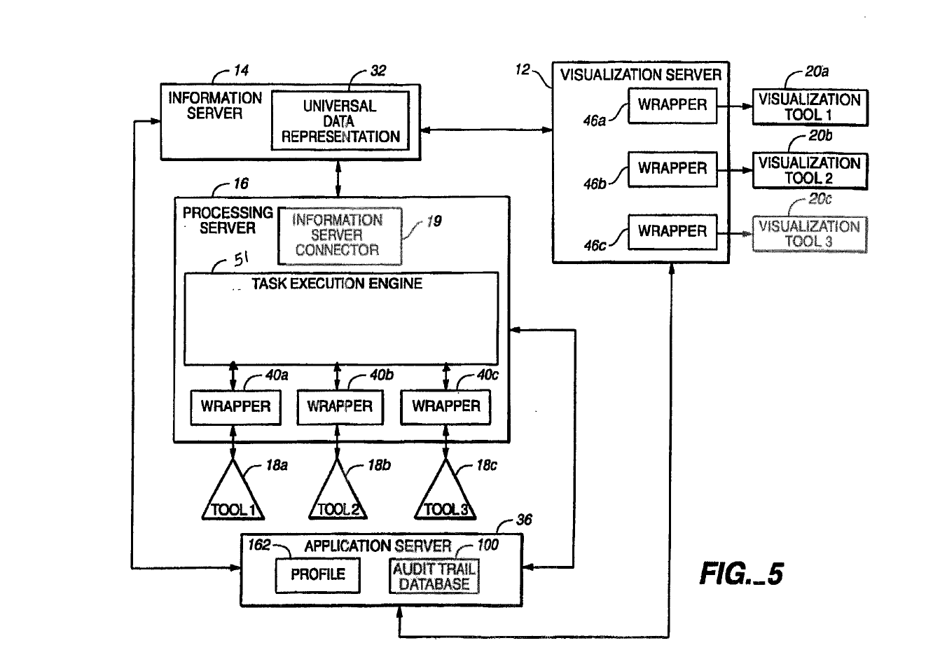

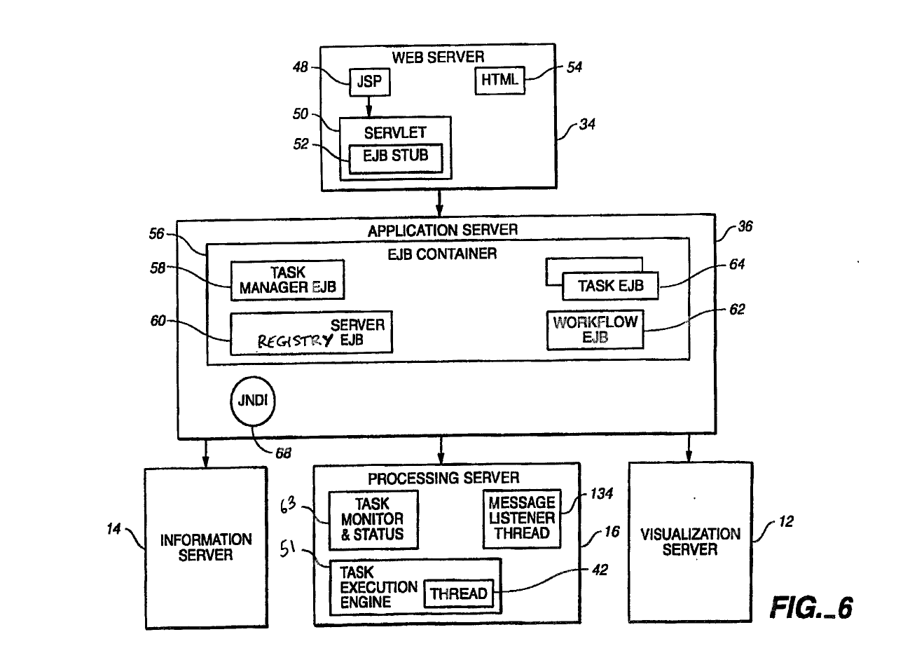

As shown in FIG. 2, a basic system architecture (which will be explained in further detail in reference to FIGS. 5 and 6) may include a web server 34, which gives users an interface to manage data, execute tasks, and view results. The web server 34 separates the user interface from the application logic contained in an application server 36 (explained in greater detail in reference to FIG. 6). The application server 36 hosts application logic and provides a link between the web server 34 and the visualization server 12, the processing server 16, and the information server 14. The information server 14 hosts and manages access to the virtual database 10.

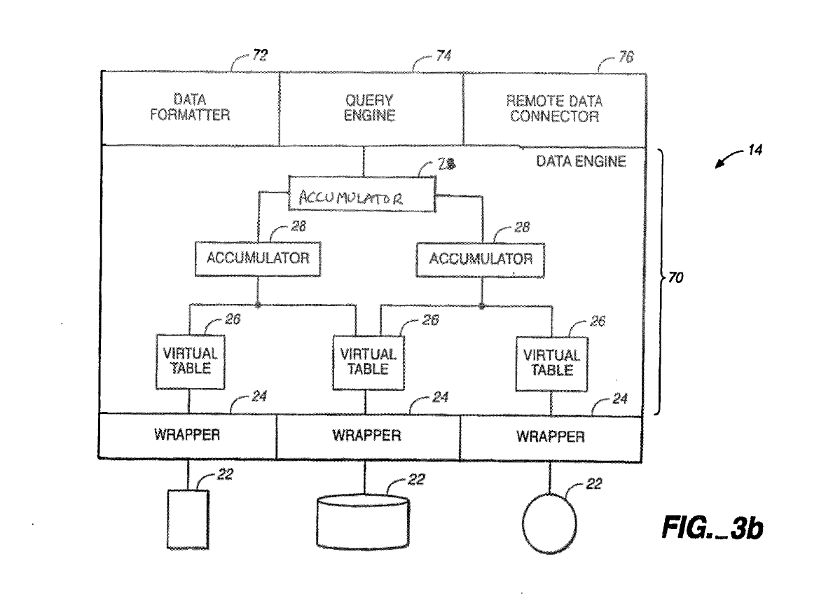

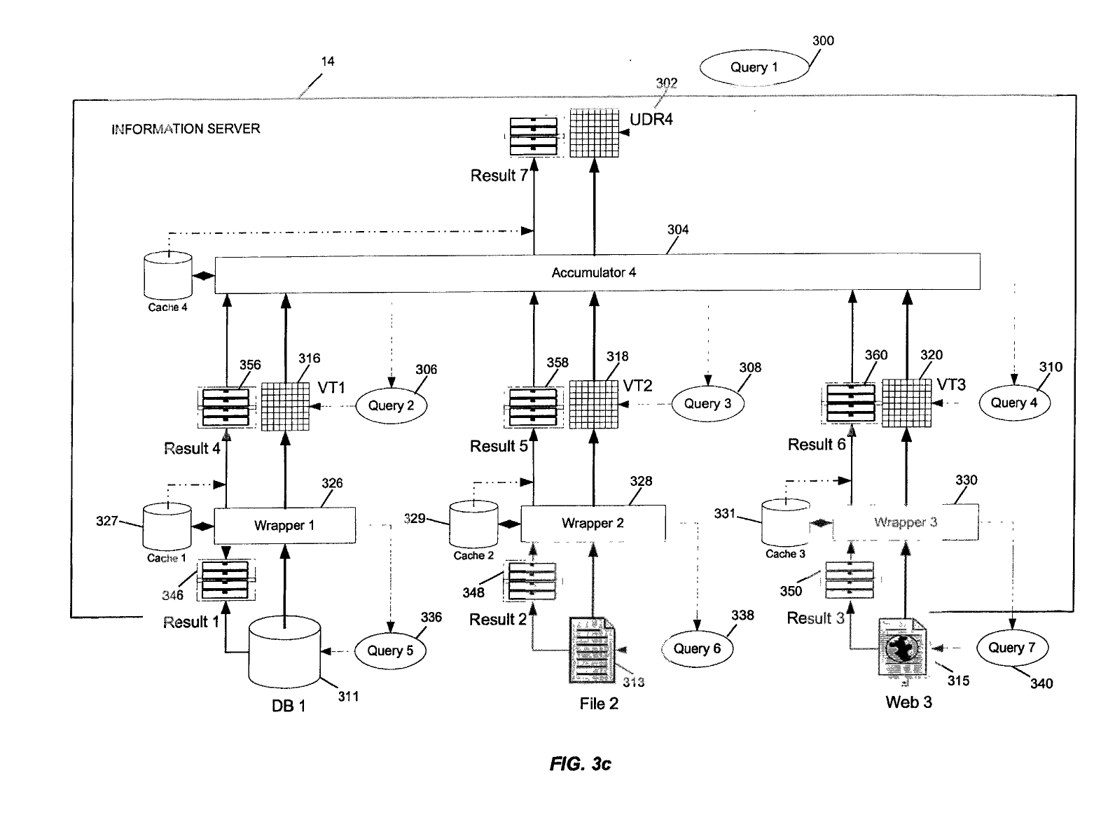

FIG. 3a is a simplified view of an information server 14. The information server 14 may include one or more data wrappers 24 which are discussed in more detail below under the heading: Anatomy of a Data Wrapper. As illustrated, wrappers 24a, 24b, 24c, and 24d each corresponds to an associated data source 22 (namely, sources 22a, 22b, 22c, 22d) that is accessed through the information server 14. Data sources 22 may be in the form of flat text files, Excel spreadsheets, extensible Markup Language XML (Extensible Markup Language) formatted documents, relational databases, data feeds from proprietary servers, and web-based data sources. For instance, database 22a has a corresponding data wrapper 24a. Similarly, flat file 22b, XML document 22c, and Web site 22d each has a corresponding wrapper (24b, 24c, and 24d, respectively). (This illustration shows four data sources 22; however, an information server can accommodate any number of heterogeneous data sources, each having a corresponding wrapper.)

Data wrappers 24 access data from the associated data source's original location and in the original format, and isolate applications receiving the data from the protocols and formats required to interact with the data sources 22. Data wrappers are generally constructed to take advantage of any native query and processing capabilities of their respective data sources in accessing information. A data wrapper 24, optionally, may cache information to a local wrapper cache 38 to improve data access speed on subsequent queries. Typically, each data wrapper 24 would have its own associated cache 38. A wrapper cache 38 can be enabled or disabled depending on each data source; generally, only data that does not change very frequently should be cached. Caching typically is most beneficial when access to the data source is slow—for example, caching data from a relational database that has a very fast access time may be less beneficial than caching data from an instrument that has slow data access. A wrapper cache 38 can be implemented in a relational database local to the information server 14, for example, within the same local area network as the information server. Each record stored in the cache is assigned a Time-to-Live (TTL) value that specifies how long (in seconds) that record should remain in the cache before it expires. Expired records are automatically removed from the cache.

Data wrappers 24 publish virtual tables 26 of information contained in each data source 22. In general, a virtual table is an object representation of the data. Virtually any implementation, such as a Java object, can be used to provide the virtual tables. Referring to FIG. 3a, a virtual table 26a is published by the wrapper 24a for database 22a, a virtual table 26b is published by wrapper 24b corresponding to flat file 22b, and so on. Virtual tables will be explained further in the Anatomy of a Data Wrapper section.

Data wrappers 24 may be implemented with an error detection and notification mechanism. This mechanism in a wrapper detects changes in the location or structure of the data for a corresponding data source. When a change is detected that cannot be handled by the wrapper, the wrapper stops providing data and it transmits a notification (i.e., a request for repair) to a self-healing manager (SHM) component. The SHM contacts a support site) and looks for updates to the wrapper. The notification can be transmitted using any messaging protocol such as Simple Mail Transfer Protocol (SMTP), or HyperText Transport Protocol (HTTP) post.

The self-healing manager (SHM) may be implemented as a separate process running on a computer in communication, either locally or remotely, with the platform. The SHM continually polls until an update is available. The frequency of the polling is a tunable parameter and depends on the context of the application. When the SHM receives a request for repair, it first determines whether an update exists for the wrapper in question. If there is, the update is downloaded and installed by the SHM. Wrapper updates can be downloaded from the information server and installed to replace the defective wrapper even while the wrapper is running. If no update is available, the SHM notifies a support site, so that support personnel will prepare an update. When the update is ready, it is posted by the support personnel to the support site so that it can be downloaded and installed by the SHM on the next polling cycle, as has been described above. When the wrapper is updated, the wrapper resumes providing data. For each subsequent error that is detected, the wrapper sends another notification and takes itself off-line until it is has been replaced by a replacement wrapper capable of processing the data without error. The self-healing mechanism is not limited to wrappers in the information server 14—it is also available for wrappers on the processing server 16 and visualization server 12, and accumulators as discussed below.

An accumulator 28 aggregates virtual tables 26 into a single universal data representation (UDR) 32. Further details of accumulators are discussed below under the heading: Anatomy of an Accumulator. An information server may have more than one accumulator. For example, different accumulators may be required for different types of data being provided by an information server; or, one accumulator may be configured to receive as an input a UDR provided by another accumulator. In general, an information server may include as many accumulators as appropriate to fulfill its data-providing function. Moreover, these accumulators may be arranged in multiple, interconnected levels to aggregate and normalize the gathered data as desired. An accumulator optionally may have a local cache 30 to store frequently requested and relatively static data.

Accumulators 28 may be layered to yield an object representation of a combination of data sources, i.e., a virtual repository of the information in the combined data sources. Each accumulator creates a potentially unique data representation that can be thought of as a building block and each of these building blocks can be put together in any arbitrary fashion to come up with any other desired data representation. Over time, different virtual repositories—a sequence repository, a gene expression repository, and a protein structure repository, for instance—may be created. Users may search for information in these repositories for several domains.

An accumulator not only aggregates the data, but it also may normalize and de-duplicate the aggregated data. Normalization may take place at two levels. The first, data normalization, applies algorithms to normalize the data against known reference values. The type and nature of algorithms to be used for data normalization is highly context specific and depends on the nature of the data to be normalized. Vocabulary normalization, the second form of normalization performed by the accumulator, applies a domain-specific ontology to normalize the vocabulary across data sources. For example, if one data source refers to “human” data while source refers to “Homo sapiens” data, the accumulator will employ a synonym-based replacement of some data to normalize the sources (i.e., replace “Homo sapiens” with “human”). In another example, if one data source has a column labeled “Sequence ID” and another data source has a column labeled “Accession Number,” the accumulator logic recognizes these are identical concepts and will take the different column names and map them to a single column with a single name.

Duplicate data removal occurs when the same data appears in two different sources. The accumulator will determine which source is to be used; for example, if two data sources contain the same information on a topic, but one source also contains additional information, the source with additional information will be used. See the Anatomy of an Accumulator section below for additional details regarding normalization and de-duplication.

FIG. 3b offers a more detailed view of an information server 14. The information server 14 contains four main modules—a data engine 70, a data formatter 72, a query engine 74, and a remote data connector 76.

The data engine 70 has largely been described. It combines data from multiple data sources 22 and provides virtual schemas of related aggregated data. Wrappers 24 and accumulators 28 are used to aggregate data in a common format; as has been described, wrappers 24 publish virtual tables 26, which are then used by accumulators 28 to aggregate, normalize, and de-duplicate the data.

The example data engine 70 shown in FIG. 3b includes three accumulators 82 arranged in a hierarchical manner. The two lower level accumulators each generates a different data representation which then are received by the top level accumulator and used to generate yet another data representation which then are received by the top level accumulator and used to generate yet another data representation. Virtually any number of accumulators can be layered, or nested, in this manner to generate different data representations as desired.

Data formatter 72 takes inputs from the universal data representation produced by accumulators 28 and outputs the data in a specific format. For example, a query issued to multiple data sources returning DNA sequence records can be formatted using the data formatter 72 in GenBank format, EMBL (European Molecular Biology Laboratory) format, GCG (Genetics Computer Group) format, or FASTA format. If the data has to be in a certain format before it can be operated on, the data formatter 72 satisfies these requirements as part of the data query.

Query engine 74 is an interpreter that translates a query (usually an SQL query) into calls to individual accumulators 28 and wrappers 24. An example query might be:

SELECT ACCESSION_NUMBER, ORGANISM, SEQUENCE,
MOLECULE_TYPE
FROM vMOLECULE
WHERE CREATE_DATE>“Dec 10, 1999” AND SEQUENCE_SIZE>
40000

FIG. 3c shows a block diagram for a process of performing a query. A user query 300 is received by an information server 14. The query engine at the information server 14 evaluates the query 300 and directs it to the UDR 302 output of the accumulator 304. The query executor of accumulator 304 receives the query, evaluates the query to determine what information it needs from each of the virtual tables that are inputs to the accumulator, and creates new queries 306, 308, 310 that will be sent to associated virtual tables 316, 318, 320. Each of the wrappers 326, 328, 330 receives its respective query 300, 306, 308, 310, and evaluates the query to determine what information needs to be retrieved from the wrapped data sources 311, 313, 315 Each wrapper then creates queries 336, 338, 340 in the native query language of each data source 311, 313, 315 and sends it to that data source. The output of the queries 336, 338, 340 produce a list of records 346, 348, 350. The results are then transformed by the wrapper into a physical recordset 356, 358, 360 in the virtual table output format 316, 318, 320. If a detail record exists in the wrapper cache 327,329,331 the record is retrieved out of the cache and stored in the corresponding recordset 356, 358, 360. Otherwise, the detail record is retrieved directly from the data source 311, 313, 315 and transformed to the corresponding recordset 356, 358, 360.

Once the query results 356, 358, 360 from each of the wrappers is generated, Accumulator 4 iterates through each of the records in each of the recordsets 356, 358, 360, and combines them using the data normalization, vocabulary normalization, and de-duplication logic within the accumulator to create Result 362 in the UDR4 format. Result 7 is then returned as the result satisfying Query 300.

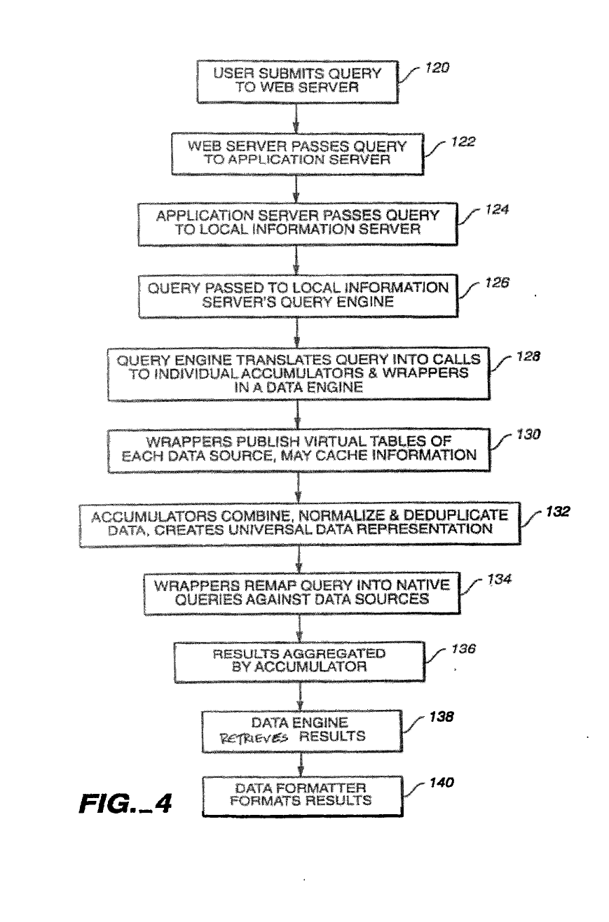

As shown in FIG. 4, a search begins when a user submits a query through a user interface to the web server (step 120). The web server passes this query to the application server (step 122), a process described in greater detail below in reference to FIG. 6. The application server then passes the query to the local information server in SQL format (step 124), a process also described in reference to FIG. 6. The query is then passed to the local information server's query engine for evaluation (step 126). The query engine translates the query into calls to individual accumulators and/or wrappers contained in the data engine (step 128).

The wrappers publish virtual tables of each data source (step 130). The accumulators then combine and normalize the data to create a universal data representation of the data (step 132).

Once a universal data representation of the data is available, and it has been determined which data sources are best suited to provide certain types of information, the wrappers translate the query into the data source's native query syntax (step 134). This takes advantage of the rich query interface of each data source. Where a rich query interface is not available within the data source, the wrapper will perform the query on the fly as it is generating the recordset. For example, consider the sample SQL query below:

SELECT ACCESSION_NUMBER, ORGANISM, SEQUENCE,
MOLECULE_TYPE
FROM vMOLECULE
WHERE CREATE_DATE>“Dec 10, 1999” AND SEQUENCE_SIZE>
40000

Note that one of the query constraints is SEQUENCE_SIZE>40000. Suppose that the particular data source to be queried does not allow for querying based on SEQUENCE_SIZE. In such a case, the wrapper would eliminate the SEQUENCE_SIZE constraint from the query and perform the query with the remaining constraints. But as the wrapper is proceeding through each resulting record to generate the list of results, the wrapper will manually check SEQUENCE_SIZE and only return those records with SEQUENCE_SIZE>40000. In other words, the wrapper filters the results received from the data source to impose the query restraint (SEQUENCE_SIZE) that could not be handled by the data's sources native query language.

The results of this query are aggregated by the accumulator (step 136). The information server's data engine retrieves the results from the accumulator (step 138). The information server's data formatter formats the results into any required format and stores them for subsequent analysis (step 140).

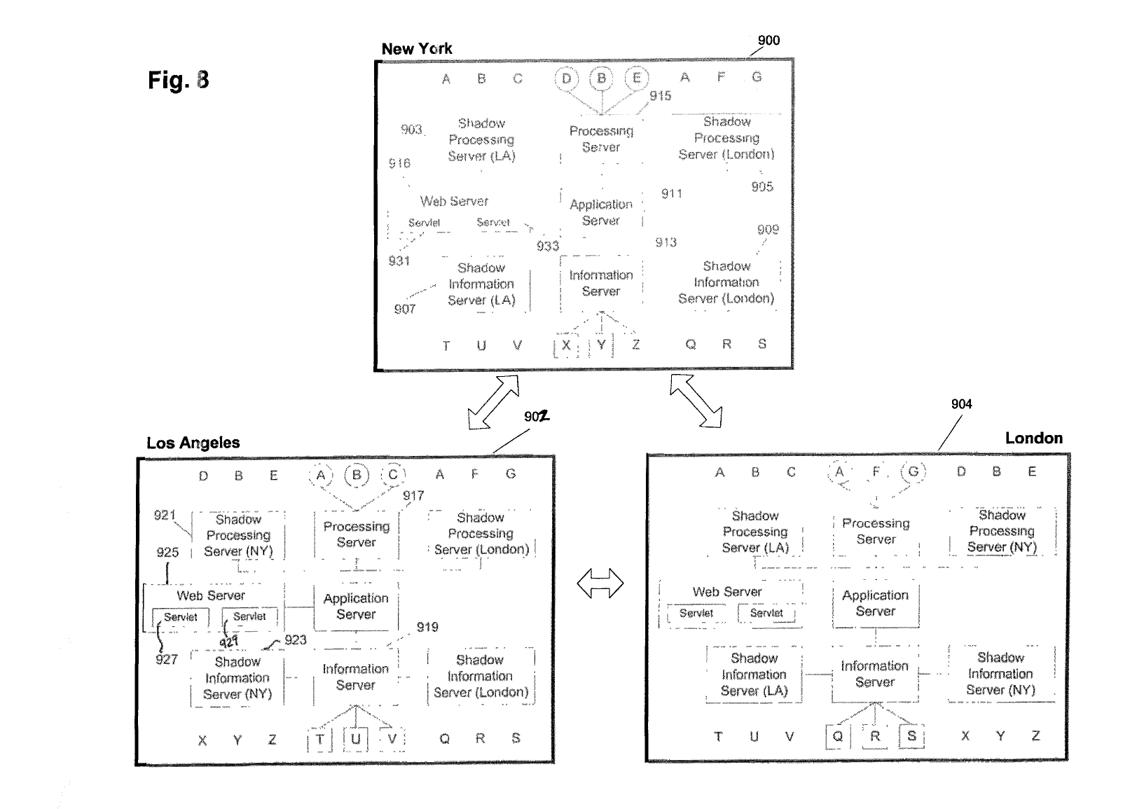

If a query is requesting data that is coming from remote information servers, the Remote data connector 76 is used to pass the data request to a registered shadow information server to retrieve results from the remote information server (this process will be discussed in detail in reference to FIG. 8), and manager the satisfactory completion of the request. A data request is any request to retrieve data from the information server. It could be a query, or merely a request to retrieve all the results of an analysis by name. The data requester, e.g., an application, therefore only has to deal with the local information server but can transparently obtain data from any remote server.

As illustrated in FIG. 5, the data obtained by the information server 14 and made available in the UDR 32 can be analyzed by the processing server 16 or viewed by the visualization server 12. Virtually any number of analysis tools 18 (illustrated as tools 18a, 18b, 18c) can be linked by the processing server 16. The analysis tools 18 (e.g., data processing applications) may require data in different formats and may run on different platforms, such as Solaris on Sun Enterprise, WinNT/2000 and Linux on Intel, Tru64 on Compaq AlphaServer, and IRIX on SGI Origin or proprietary hardware platforms such as the Paracel GeneMatcher or TimeLogic DeCypher. Analysis tools do not have to reside locally in order to be incorporated into the processing server—Web-accessible tools can also be transparently incorporated into the processing server to form a compute service.

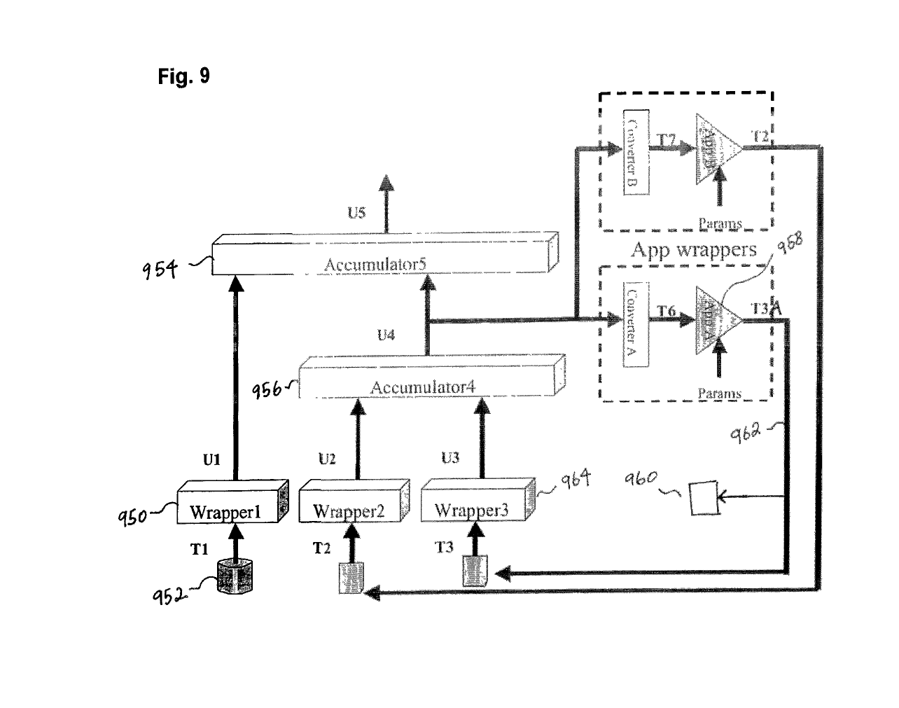

The processing server 16 requests data in the UDR 32 through the information server connector 19, an API for communicating with the information server. Application wrappers 40 specifically written for each tool 18 (so, in the illustration, tool 18a has a corresponding wrapper 40a, tool 18b corresponds with wrapper 40b, tool 18c corresponds with wrapper 40c) convert data into desired input format of the corresponding tool 18 by data transformation rules when necessary. The particular data transformation rules are application-specific rules necessary to prepare the inputs for the tool to run correctly. The processing server 16, using the wrappers 40 provides a consistent interface for the analysis tools and hides from the invoking application the execution details of the analysis tools 18, such as input formats, output formats, platform, and parameters required to run the tool 18. The interface provided by the processing server is application-specific and can be any implementation that effectively communicates the parameters and output format between the application and the tools; in one embodiment, the interface encodes the parameters in XML. As will be shown below in FIG. 9, tools 18 do not need to be local but may be transparently incorporated into the processing server 16 from remote locations.

Results of each analysis are stored in the tool's native format but wrapped as an object, which may later be converted into the UDR by the information server 14 so that other analysis tools 18 may access the results as part of an analysis workflow. An analysis workflow is a pipelined way to chain together a group of tasks wherein the output of one task can be used as the input into another task to increase throughput of the analysis.

The application server 36 keeps a log of a user's actions in an audit trail 100, which may be as simple as a text file or something more structured, such as a relational database. This database can be used to generate an analysis workflow.

The visualization server 12 is a special implementation of the processing server 16. Viewers, visualizers, and data mining tools 20 (for example, desktop tools, Java applets, and viewers of data formatted in a markup language such as HyperText Markup Language (HTML), Postscript, PDF or any other desired format) are incorporated into a visualization framework to form datatype-specific visualization services that can be invoked by an application as a result of a user request to view the output of a query. The visualization framework provides an endpoint or destination for the query output. Wrappers 46 specific to each different visualization tool 20 abstract the tools 20 to form the visualization framework, illustrated as wrapper 46a for tool 20a, wrapper 46b for tool 20b, and wrapper 46c for tool 20c.

FIG. 6 illustrates a specific implementation for task execution of the basic architecture described above in reference to FIG. 2. Web server 34 provides an interface that users can use to manage data, execute tasks, and view results. The web server 34 separates the user interface from the application logic contained in the application server 36. The web interface is implemented using Java Server Pages (JSPs) 48, which enable generation of dynamic web pages and which make calls to the application server 36 for executing the application logic. In this implementation, the application logic is realized in an Enterprise JavaBeans (EJB) container 56. The web server contains an HTML module 54, which contains static Web page templates to be combined with dynamic content. A Java servlet 50 receives requests from clients, i.e., system users. An EJB stub 52 then relays the request to the application server 36.

The application server 36, as noted above, hosts the application logic and provides a link between the web server 34 and the information, processing, and visualization servers 14, 16, 12. The application logic components in this embodiment are deployed as Enterprise JavaBeans in the EJB container 56. Available processing or visualization servers 16, 12 are listed in a server registry bean 60 on the application server. Upon startup of a processing server, the processing server is registered with a Java Naming and Directory Interface (JNDI) service 68 on the application server. During the registration process, the processing server tells the application server which tools are available on the processing server.

When a request to execute a task comes from the web server 34 through the EJB stub 52, the web server 34 uses the EJB's remote interface to connect to a task manager bean 58 on the application server. The task manager bean 58 instantiates and passes on all appropriate initialization parameters to a task bean 64. When initialization is complete and the task is ready to run, the task manager bean 58 is notified to add the task to a queue of tasks on the application server. The task manager bean 58 then checks a work queue for each processing server 16 that is capable of performing the task and uses a load-balancing approach to determine which processing server is available to perform the task. If no processing server 16 is available, the task remains in the task queue until assigned to a processing server 16. The task manager bean 58 notifies the requestor that the task has been queued for execution. However, if a processing server 16 is available, the task manager bean 58 sends a message to one of the processing servers 16 to execute the task. The message is received by a message listener thread 134 in the processing server 16 and threads 42 are created for the task in the task execution engine 51. The status of the task is tracked by the task monitor thread 63 within the processing server 16. The requestor can request to receive periodic notices regarding the task status.

A workflow bean 62 in the application server 36 tracks statistics, such as the amount of time in a job queue, time-to-completion, and error states for all running tasks.

The elements that have been described also can be implemented to run tasks on the information and visualization servers 14, 12.

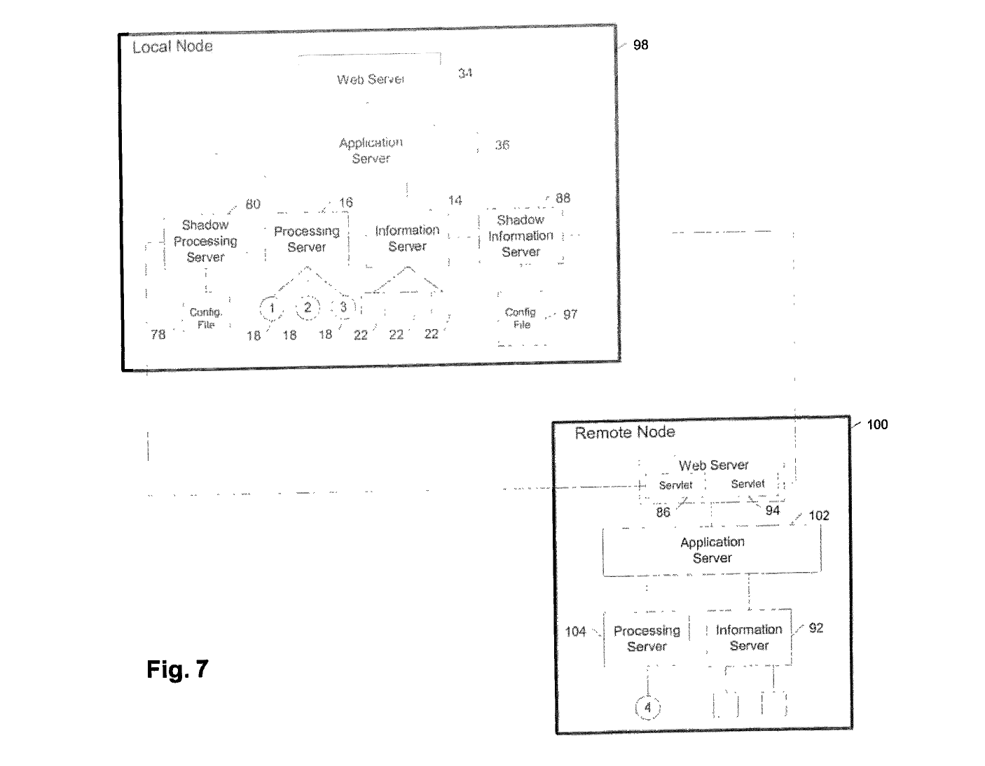

FIG. 7 illustrates the system architecture at a local node 98. The architecture is extended to include shadow servers 80, 88 serving as proxies for events happening on a remote node 100. The shadow processing server 80 and the shadow information server 88 are responsible for accessing tools and data, respectively, located on one or more remote nodes 100; optimally, each shadow server is responsible for only a single remote node 100. Multiple shadow servers may exist in one node.

The shadow servers 80, 88 each have a configuration file 78, 97 containing authentication credentials for communicating with the servers on remote node 100. The configuration file 78, 97 also specifies the tools/data resident on the remote node 100 and this information is provided to the application server 36 during registration of the shadow processing server 80 with the application server 36. The registration process is the same as with the local processing server discussed above.

The following describes how a shadow processing server 80 can be used to access a tool (e.g., a data processing or analysis application) located on a remote node 100 access: When the application server 36 at the local node 98 receives from web server 34 a user request to access a Tool 4, a task manager EJB on the application server 36 consults a registry of processing servers (maintained by application server 36 and containing both local and shadow servers) to determine which processing server can provide Tool 4. In the case where Tool 4 resides on a remote node 100, the task manager EJB assigns the task to the shadow processing server 80 responsible for remote node 100.

Upon receiving the request, the shadow processing server 80 constructs an XML (Extensible Markup Language) message describing the task and uses HTTPS (HyperText Transmission Protocol, Secure) to forward the XML message to a servlet 86 on the web server of the remote node 100. The servlet 86, upon receiving the XML message from the shadow processing server 80, reads the XML message, decomposes the message into a local task, and responds back to the shadow processing server 80 with another XML message containing the data requirements for performing the task.

The shadow processing server 80 receives the responding message from servlet 86, decodes the message, and communicates with local information server 14 to obtain the input data and send it using an HTTPS POST operation to a data handling servlet 94 of the remote node 100. The data handling servlet 94 reads the data streams and caches the data at the remote information server 92 on the remote node 100, thereby satisfying the input requirements for the task. The data handling servlet 94 returns a status to the shadow processing server 80, which then sends another XML message to the remote application servlet 86 to schedule the task for execution on the remote node 100.

The servlet 86 connects to the remote application server 102 and communicates with task manager at node 100 to create a task and schedule it to run on the remote processing server 104. The shadow processing server 80 (which is responsible for reporting the task status back to application server 36) continually polls servlet 86 for the status of the task. This polling occurs in the form of an XML message. Upon receiving the status request, the servlet 86 asks the application server 102 for status and responds back to the shadow processing server 80. The shadow processing server 80 uses the status received from the servlet 86 to update the task status for the task assigned to it from application server 36. When the shadow processing server 80 receives notice that the task is complete, the shadow processing server 80 requests the resulting data from the data handling servlet 94. The servlet 94 communicates with the remote information server 92 to retrieve the results and to pass them to the shadow processing server 80. The shadow processing server 80 may request the local information server 14 to store the results and then informs the application server 36 that the task is complete.

The following describes how the shadow information server 88 can be used to access data residing on a remote node 100. All user requests to access data are sent first to the local information server 14. Then, if some or all of the requested data is non-local, the local information server 14 passes the request to one or more shadow information servers 88 (depending on where the non-local data is), each of which interacts with a remote information server 92 to obtain the requested remote data from one or more remote data sources 90 connected to the remote information server 92. A remote information server 92 contains the same modules as the information server 14, described above, and processes queries in the same manner.

The local information server 14 has a remote data connector 76, which the server uses to communicate with one or more shadow information servers 88. The shadow information server 88 formats data requests as XML messages and passes the message via HTTPS to a data handling servlet 94 on the remote node 100. The data handling servlet 94 receives the XML messages, decodes the message, and sends the request to the remote information server 92. Servlet 94 authenticates the messages received from shadow information server 88, communicates with the remote information server 92, and handles the data transmission between the shadow server 88 and the remote information server 92. The remote information server 92, when it receives a data request from the data handling servlet 94, completes the data request, and sends the results back to the data handling servlet 94. The data handling servlet 94 returns the data to the shadow information server 88 as a response to the XML message that the servlet 94 received. The shadow server 88 caches the data locally and sends the data through the remote data connector to the information server 14.

FIG. 8 is a block diagram showing an example of a split node distributed over three sites 900, 902 and 904. As used herein, a split node is one in which the available analysis functionality and/or available data sources are distributed across two or more sites. Such a configuration may be used, for example, in a distributed enterprise having facilities in three different geographic locations such as London, New York and Los Angeles. Although each site has only a subset of the enterprise's available tools and/or data sources locally present, a user at any of the sites has virtual and transparent access to all of the enterprise's tools and data sources through a system of shadow servers. In FIG. 8, tools and data sources that are locally present are shown in solid lines while tools and data sources that are virtually present (i.e., located remotely but made transparently available) are shown in dotted lines.

As shown in FIG. 8, for example, the enterprise's New York site 900 has only tools D, B, E and data sources X, Y, Z physically present at site 900. A user at the New York site 900 may access the tools D, B, E and/or the data sources X, Y, Z by interfacing directly with a web server 916, which receives the user's data or processing request and passes it to the application server 911. The application server 911 in turn fulfills the request by initiating a task to selectively access the processing server 915 and/or the information server 913 as appropriate.

In addition, shadow servers 903, 905, 907, 909 at the New York site 900 enable a user at that site to transparently and seamlessly access any of the tools A, B, C or data sources T, U, V at the Los Angeles site 902 and/or any of the tools A, F, G or data sources Q, R, S at the London site 904. More particularly, the New York site 900 includes a separate shadow processing server 903, 905 for each of the other sites 902 and 904, respectively. In the manner described with reference to FIG. 7, the LA shadow processing server 903 registers with the application server 911 to inform the application server 911 that tools A, B, C are available at the Los Angeles site 902. Consequently, the tools present at the Los Angeles site 902 are presented to a user at the New York site 900 as being available for usage. Because the availability of these remote tools is presented to the user in the same manner as the availability of the local tools (that is, the remote tools are presented in a location-transparent manner), the user at the New York site 900 may be unaware that the tools are located remotely.

Connections between servers across site boundaries are not shown in FIG. 8 for the sake of clarity. However, each shadow server at a site has a communications connection to a servlet executing in a web server at a corresponding remote site. For example, the shadow processing server (LA) 903 at site 900 has a connection to a servlet 927 at site 902 and the shadow information server (LA) 907 at site 900 has a connection to a servlet 929 at site 902. Similarly, the shadow processing server (NY) 921 at site 902 has a connection to a servlet 931 at site 900 and the shadow information server (NY) 923 has a connection to a servlet 933 at site 900. Analogous connections exist for sites 902-904 and for sites 900-904 between shadow servers and associated servlets. A request from a remote site received by a servlet in a web browser, whether for data or processing, is passed on to that site's application server, which in turn initiates a task to fulfill the request. Request results and/or status subsequently are returned to the servlet, which communicates the results/status back to the originating shadow server. In this process, the application server effectively is unaware that the request was originated remotely and thus acts to fulfill the request in the same manner as if it were initiated locally. In this way, each site in the split node can make all of the enterprise's tools and data sources available, either physically or virtually, to users at any of the sites.

The tools and/or data sources present at sites in a split node may be mutually exclusive, partially overlapping, or entirely redundant, depending on implementation and design preferences. As shown in FIG. 8, for example, the data sources available at each of the sites 900, 902, 904 are unique and mutually exclusive. This may be the case, for example, where each of the data sources corresponds to a data acquisition system or instrument that is best situated at a particular site due to site-specific characteristics such as geography, environment, research specialties, associated resources or the like.

In contrast, partial overlap exists in the various tools present at each of the sites 900, 902, 904. Tool A is present, for example, both at site 902 and site 904 and Tool B is present both at site 902 and site 900. This redundancy can be used advantageously for a variety of purposes such as load balancing, fault tolerance, and query optimization. Similar advantages may arise by making redundant data sources available at two or more sites in a split node. Other tools in the split node example of FIG. 8—for example, tools C, D, E, F and G—are present only at a single site in the split node. This may be the case, e.g., when a particular tool has an affinity for a particular computing environment. For example, a tool may operate best in a computing environment that has hardware accelerators, parallel processors or the like, which may be present only at a particular site in the split node. Alternatively, or in addition, a tool may be licensed only to operate at a particular site or may require the local presence of a particular data repository that is too large or expensive to replicate at a remote site. Similar considerations may arise in deciding whether to provide a data source at multiple sites or only a single site.

FIG. 9 illustrates an example of layering accumulators to generate different data representations. This example shows how accumulators can be nested to produce different UDRs, how UDRs can be used as inputs into data analysis tools, and how the results of the analysis can be fed back into the system to be used as inputs for a second iteration.

Referring to FIG. 9, Wrapper1 950 retrieves data from a specified location, here depicted as database 952 and maps the useful fields into virtual table U1. U1 is then treated as input into Accumulator5 954. A second input into Accumulator5 954 is not a virtual table, but rather a UDR U4 that is the output of a second Accumulator4 956 that is nested underneath Accumulator5 954. Accumulator5 954 aggregates, normalizes and de-duplicates the data in U1 and U4 to produce UDR U5.

UDR U4, in addition to being fed into Accumulator5 954, could also be used as input into one or more tools or applications. An application wrapper AppA 958 takes input data from UDR U4 and converts the data into T6, which represents the input format required by a particular application or tool. Once the tool has completed its execution, the output T3A can be stored in one or more formats for use by one or more visualization servers. Alternatively, output T3A can be re-used as input back into the information servers, here shown by feedback loop 962. To execute the feedback loop 962, AppA 958 converts T3A into T3, which is the input format for Wrappers3 964. AppA 960 then stores T3 in the location where Wrapper3 typically retrieves data. In a second iteration, Wrapper3 could retrieve the new T3 and pass it to Accumulator4 956 to form a new UDR U4.

By nesting accumulators and feeding the outputs of the analysis tools back into the system, new data representations can be generated that are richer and more usable than the raw representations provided by the data sources.

The components and techniques described here may be implemented in digital electronic circuitry, or in computer hardware, firmware, software, or in combinations of them. An apparatus can be implemented in a computer program product tangibly embodied in a machine-readable storage device for execution by a programmable processor; and method steps can be performed by a programmable processor executing a program of instructions to perform functions by operating on input data and generating output. These techniques may be implemented advantageously in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. The essential elements of a computer are a processor for executing instructions and a memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, a computer system may have a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

While the systems and techniques described here can be used for bioinformatics and chem-informatics purposes, they are not limited to use in these fields, and the platform may be used to integrate information in any field.

Anatomy of a Data Wrapper

The data wrapper's goal is to abstract a data source by hiding the details of access, data organization, and query to that data source, and also to provide an object model of the data within that source. A data wrapper may include the following elements:

1. Data source connection—This is used to define the connection to the data source. This can be any protocol that has a programmatic interface, like, HTTP, HTTPS, NNTP (Network News Transport Protocol), POP3 (Post Office Protocol), IMAP4 (Internet Message Access Protocol), FTP (File Transfer Protocol), FILE system access, JDBC (Java Database Connectivity), RMI (Remote Method Invocation), CORBA (Common Object Request Broker Architecture), sockets, etc.

a. Authentication—If the data source requires user authentication in order to access the site, then the credentials used to connect to the data source are passed as part of creating the connection. These can take three forms—user-specific, site-specific or anonymous. In the user-specific case, the authentication credentials from the user are passed to the wrapper as the request for data is made. In the site-specific case, all users use a common set of authentication credentials that are passed to the wrapper with every data request. In the anonymous case, no authentication credentials need to be passed. The authentication methods allow for the preservation of security models that are already established at the data source level.

b. Session/transaction management—An active connection to a data source may need to maintain state information in order to properly navigate to the appropriate point in the data stream. The state information can be in the form of URL-encoded session parameters, web site cookies, a list of files in the file system that remain to be processed, a database connection with its attributes, etc.

2. Query execution—Typically, all data requests go though a query execution step. The query executor executes even simple queries, such as “retrieve record X from the data source”. Its function is to successfully return the subset of records that satisfy the query. The queries can come to the wrapper in a variety of ways, including through SQL, or through Java objects where the filter criteria is passed programmatically (for example, via a function call with fields passed as parameters to the function.)

a. Evaluation—The query executor evaluates the query and formulates conditions for filtering the results. This is also an error checking step to make sure that the user is submitting queries that make sense, and make use of the fields accessible by this wrapper.

b. Mapping to native query language—The queries are issued against the fields in the UDR and the query executor maps the query conditions to the native query language of the data source. If a query condition cannot be constrained by the native query language, then the wrapper prior to returning the result filters the records.

c. Iteration of query results—After the native query is passed to the data source, a list of hits is returned. The list may be returned as one large list, or paginated. The iterator goes through the entire list or all the pages and builds a master list of records (record set) that satisfy the query. The recordset may need to be further filtered by the wrapper to satisfy any conditions that could not be constrained by the native query language.

3. Data buffering—The results of queries are buffered in-memory so that further manipulation of the resulting recordsets may occur. Both the list of results and the details of each record are buffered in memory.

4. Data extraction—Each field from the record detail must be extracted from the buffer. This involves both understanding the organization of the data in the buffer, the parsing of the data, and the navigation around the buffer to extract the data for all the fields. For databases, this may be simply the access of the fields from the resulting recordset. For text or web data sources, it may mean the resilient text parsing, and the drill-downs to subsequent pages that contain the rest of the fields of a complete record.

5. Error handling—In order to maintain the uptime of a system, each component must be able to sense errors or changes to the data source. Errors can be of four forms: system errors, hard errors, soft errors, or warnings. (1) The system errors are such things as HTTP 500 Server Error, Connection Timeout, DNS (Domain Name Service) Entry not found, etc. Errors that have nothing to do with the data that is trying to be accessed, rather, the system that the wrapper is trying to access has some error condition that prevents the successful extraction of the data. (2) The hard errors are such things as table name not found, field not found, URL gives HTTP 404 Not Found error, etc. These errors would cause the wrapper to “break”, and in need of repair through the self-healing manager. (3) Soft errors are such things as new fields that are discovered in the tables of a database wrapper (through a database reverse engineering process), or on a file or web page where new fields appear in the data buffer as part of parsing a structured document. These errors, although not critical to the operation of the wrapper, may need human review to check for the semantic meaning of the new fields and their importance for inclusion into the UDR. (4) Warnings are solely for notification purposes; the system does not perform any action in response to the warning.

a. Self-healing manager registration—Each component is registered with a self-healing manager that is responsible for maintaining the correct state of the components. The information that is registered with the self-healing manager is the component class path (i.e. com.adaapt.wrapper.web.NCBIEntrezWebWrapper), the version of the component in Major.Minor.Revision format (i.e. 1.0.4), the author's name and email address, and the support server that is responsible for keeping this component up to date (i.e. support.entigen.com/patch/patchserver).

b. Dependent components list—The components that are used by this component that may also need to be placed in an error state if this component goes into an error state. This allows fixes in the components in the dependency list to clear the error state of this component assuming that the error that was encountered was caused by the component that was updated.

c. “Self-test”—Once a component was been updated, the self-test routine goes through a series of canonical tests against the data source to make sure that it is operating as normal. A self-test OK message doesn't mean that this component will not encounter any other errors, but it does mean that the tests that were encoded in the self-test routine did pass successfully and thus there is a high degree of confidence that this component will be stable going forward, and that is should be taken out of the error state.

d. Error detection—The error checking is placed in Java TRY/CATCH blocks around critical actions performed during all steps in the wrapping process. For example, around the connection to the data source, the parsing of the data and the extraction of each individual field, the testing of the data type of that field, the reverse-engineering of the database to determine the expected organization within the database, etc. It is up to the programmer to throw the appropriate errors that are caught by the self-healing manager so that the appropriate actions can be taken.

e. Notification—The notification to the self-healing manager happens as a result of throwing an error during the error detection blocks within the wrapper. In addition to throwing an error, the state of the wrapper at the time of the error is also sent to the self-healing manager so that the error is logged appropriately and the state is communicated to the author of the component for error reproducing and repair.

f. Error state—The components are put in an error state that can be polled by the self-healing manager. The valid error states (besides the OK state) are: Offline, Cache-Only, Warning. The offline state is when a hard error has occurred and the component cannot function according to the specifications. The Cache-Only state is when the component is temporarily offline, yet is operating on data from the cache. The Warning state is when soft errors or warnings have occurred, but the component is still functioning normally.

6. Output—The output of the data wrapper is a virtual table implemented as a group of Java objects that define the semantically correct informational content of the data source. The instance variables of each of the Java objects act as columns in the virtual table and can be queried programmatically. Each of these columns has meta-information associated with it that contains a human-readable name that can be used to automatically build user-interfaces from the UDR.

a. Name of output—Each wrapper produces a single output that is named.

b. Data type of output—The data type of the output is also named as a string that can later be used to convert from one named type to another (provided that a conversion mechanism exists).

c. Object creation—The virtual table object/class is instantiated when records are created. The java class can have other classes or lists of classes as instance variables of that class. Each embedded class can be treated as a linked table containing the related information for that record instance. For example, a class for a sequence object may have the following fields:

| | |
|---|---|
| Sequence | Publication |
| { | { |
| int sequenceID; | int pubID; |
| String organism; | String title; |
| Date createDate; | String authors; |
| Publication pubs[]; | Date pubDate; |
| String sequence; | String journal; |
| } | } |

The database will have two tables, one for each class, even though the Publication class is only used within the Sequence object. The links between the Sequence and Publication tables will be through the sequenceID fields in both tables.

| | |
|---|---|
| sequence_table ( | publication_table ( |
| sequenceID number, | sequenceID number, |
| organism varchar, | publicationID number, |
| createDate date, | title varchar, |
| sequence text | authors varchar, |
| ) | pubDate date, |
| | journal varchar |
| | ) |

In addition to defining the class that is to hold the output model, the primary key(s) is also defined for this data source as part of the meta-information.

d. Initialization—The newly created object is initialized to default parameters just prior to object population. This ensures that there are no invalid values in any of the fields of the object.

e. Object population—The object is populated with data retrieved from the Data extraction step above.

i. Data mapping—the data can be converted on the fly using one of two ways:

1. Algorithmic transformation of data—where a functional transformation of the data is required in order to set the correct value

2. Lookup table transformations of data—where the data is converted based on a lookup table that can either be in memory or in a database

ii. Column mapping—the names of columns in the virtual table may be different than the fields in the data source. For example, if the data source has two fields, DOB (Date of Birth), and Age at Onset of Disease, the output columns may be DOB, and Date at Onset of Disease. This transformation would require both a column mapping and an algorithmic transformation of the data.

1. Naming/renaming source to destination columns—columns in the output may be named differently than the data source.

2. Composite columns—two or more columns in the data source are combined to form one column in the virtual table, or one column in the data source is split into two or more columns in the virtual table.

f. Caching—As each instantiated object in the virtual table is populated with the details of the record from the data source, it can be cached in a relational database in such a way as to allow for optimal retrieval of that record out of the cache and into an object structure. As each record is written in the cache, a Time-to-Live (TTL) value for each record is set using a wrapper-specific value that reflects the update frequency of the data source. Caching can be turned on or off at the wrapper level. When a query is issued to the data source, the query is remapped and sent to the data source. After the list of hits is returned from the data source, each record is compared to the records in the cache and if the record exists in the cache (and the record has not expired past the TTL value), it is retrieved out of the cache instead of the data source. If the record does not appear in the cache, or the record has expired in the cache, then the record is retrieved from the data source as usual.

Anatomy of an Accumulator 28

As explained earlier, the accumulator's goal is to combine data from one or more data wrappers 24 and/or one or more accumulators 28 into a new UDR that represents data intelligently combined from multiple sources. The accumulator is also a custom query executor that is optimized for performance of the most common queries. An accumulator may include the following elements:

1. Inputs—Inputs can be virtual tables 26 generated by data wrappers 24 or they can be UDRs 32 generated by other accumulators 28.

2. Outputs—The output of the accumulator is a new UDR which is the result of merging the data from the various input data models and then normalizing and de-duplicating the merged data to remove inconsistent or duplicate data. See below under Normalization and De-Duplication.

3. Query execution—The queries that are sent to the accumulator are first evaluated for correctness, then mapped according to the fields in the virtual table representations of the relevant data sources. Depending on the query costs of each data source, the accumulator sends the queries to the lowest cost input sources first, and so on. If there are dependent queries, the queries are ordered by evaluation order and submitted to the virtual tables. If the queries are independent, then the queries are run in parallel and combined at the end. A good example is an AND statement vs. an OR statement. In an AND condition, if the result of one query returns no results, then there is no reason to continue the process the rest of the queries. In an OR statement, each query can be executed separately and combined at the end.

a. Evaluation—Evaluation consists of grouping query conditions together so that they can be passed to the appropriate data wrappers or accumulators for execution in the order of cost, and make decisions on whether or not to continue executing the query depending on whether the wrappers are satisfying the query requests. For an accumulator to complete a single query, multiple queries to the wrappers may be necessary.

b. Mapping—Mapping involves mapping the query conditions from the UDR of an accumulator to the fields in the virtual tables of the dependent wrappers (or to the fields in the UDR from a dependent accumulator). This mapping may require reverse-transformation of the logic that was applied to generate the field (see Anatomy of Data Wrapper, Data Mapping.)

c. Cost-based optimization—Each input source (data wrapper or accumulator) is given a numeric value for a cost that represents the speed that this particular data source may be able to complete a query, or the expected amount of data that this data source will be returning as a result of a query. A lower cost means that the data source is very fast in responding to queries, or that the typical queries that this source will receive will yield little data, and thus, it should be queried first because it may save time when the rest of the data sources are queried. The optimization based on cost will start with the lowest cost data sources first, and go to the highest cost last.

d. Iteration on of results from multiple sources—The query executor gets a cursor to the recordsets generated from the queries to each of the data wrappers or accumulators and it retrieves the records into memory so that it can combine the records into the UDR.

e. Join logic—The results of queries can be joined through in-memory manipulation of the recordsets, or in the event of large datasets, the temporary caching of intermediary results. The results of the intermediary queries are cached in the database so that they can be combined later.

4. Normalization—The data coming from multiple data sources may need to be normalized before it can be combined. There are two ways of normalization:

a. Synonym-based replacement rules—if the data from different sources is not directly comparable, it may need to be replaced with data that can be compared. The two ways of creating the synonyms are:.

i. Lookup table-driven—The synonyms for the data is stored in an in-memory lookup table for easy replacement.

ii. Data source-driven—The synonyms for the data are stored in another data source, such as a database, and are accessed directly from that source.

b. Algorithmic normalization—If there is an algorithm that can be applied to normalize the data, then the algorithm is invoked as the data is combined.

5. De-duplication—The data coming from multiple data sources can contain duplicates records. Duplicate records are determined by comparing the primary keys of records in the resulting recordsets of the query across all the data sources. The records returned as part of the recordset will be composed using records from the richest data source, or a combination of fields from both duplicate records.

a. Primary key matching—when primary keys are specified for each input data model, they can be used to directly compare records for de-duplication.

b. Algorithmic determination of primary keys—when the primary keys defined for each of the input models does not permit the direct comparison of records from different data sources, there may need to be some algorithmic manipulation of the fields so as to generate temporary primary keys that are used for record comparison.

6. Error handling—see discussion under Anatomy of a Data Wrapper.

Anatomy of An Application Wrapper 40

The application wrapper's goal is to abstract an analytical tool 18 by hiding the inputs, parameters, and outputs of the tool. An application wrapper may include the following elements:

1. Application source connection—This is used to define the connection to the application source. The general mechanisms for application executions require inputs and parameters, and produce outputs. This process can use any protocol that has a programmatic interface, like, HTTP, HTTPS, NNTP, POP3, IMAP4, FTP, FILE system access, JDBC, RMI, CORBA, sockets, etc.

a. Authentication—If the application source requires user authentication in order to access the application, then the credentials used to connect to the application are passed as part of the creating the connection. These can take three forms—anonymous, user-specific, or site-specific. In the user-specific case, the authentication credentials from the user are passed to the wrapper as the application execution is made. In the site-specific case, all users use a common set of authentication credentials that are passed to the wrapper with every application execution request. The authentication methods allow for the preservation of security models that are already established at the application level.

2. Inputs—The inputs to the application are identified by type and name. For example, in order to perform a sequence similarity search, there are two inputs that must be provided: a sequence, and a reference database. The program parameters allow the user to tune the algorithm to the data provided.

a. Name—The name of the input.

b. Data-type specification—The data type of the input that can be used to request the appropriate data type from the output data model (see below for description of output data model.)

c. Preparation—The conversion of the data from an output data model to the input format required by the application to run.

i. Local caching of converted inputs—The prepared input can be cached (either in the file system or in a database) so that subsequent access to the same data is fast.

3. Program parameters—The parameters used to tune the execution of the program. Each parameter is named, has a data type, and a range limit.

a. Name—Name of the parameter.

b. Description—Human readable name of the parameter

c. Data type—The parameter type (either integer, float, string, boolean, selection).

d. Range limits—Depending on the data type it can be either numeric limits, selection limits, string length limits, etc.

4. Application execution—Once all the inputs and parameters are specified, the application can be executed. Depending on whether the application is a command-line tool, RMI or CORBA service, or an algorithm delivered as a Java class, the application invocation method may vary.

a. Command line generation—If the tools is a command-line tool, a template for the command line is specified where all the parameters can be plugged in using the Inputs and Program parameters. Likewise, for tools that are available as RMI services or CORBA services, the wrapper passes the inputs and parameters through the interfaces defined by the service.

b. Execution—The actual execution of the application happens in a separate thread or process that can be monitored by the wrapper, and killed by the user, if required.

c. Error trapping—The wrapper contains TRY/CATCH blocks to catch runtime errors, or other normal or abnormal exit errors.

5. Error handling—See discussion under Anatomy of a Data Wrapper.

6. Data Buffering—The output of the application execution is buffered in memory, or written to the disk.

7. Data extraction—After the data is buffered, the software processes the data produce the output. The data extraction step just following the execution of the program may only contain summary information, and the full details may be extracted in a subsequent step as the full result is used as part of another analysis.

8. Output Data Model—Results of each analysis are stored in the tool's native format but wrapped to produce a virtual table which is later converted into the UDR by the information server 14.

a. Caching of output—For some applications, caching is automatic since the results are written to the file system before they are made available through the wrapper. Similar to the data wrapper, the application result caching allows the results to be managed by the system. Unlike the data wrapper, a TTL value is not necessary since the results should always be the same if the same inputs and parameters are used. Thus to trigger a re-analysis, the software need only monitor for changes to either the inputs or the parameters—if either one is changed, then the result may not be valid and must be recomputed.

What is claimed is:

1. A method of facilitating access to data, the method comprising:
providing each of a plurality of heterogeneous data sources with an associated software wrapper that provides an object representation of data in the data source;
providing outputs of one or more software wrappers to a first software accumulator that aggregates data from data sources to generate a first aggregate data representation; and
using at least a second software accumulator to generate a second aggregate data representation different from the first aggregate data representation based at least in part on the first aggregate data representation from the first software accumulator.

2. The method of claim 1 wherein at least one of the software wrappers hides one or more details of the data source.

3. The method of claim 2 wherein the one or more details hidden by the software wrapper comprise one or more of a data format of the data source and a location of the data source.

4. The method of claim 1 wherein the second aggregate data representation is generated using the first aggregate data representation from the first software accumulator and data from one or more software wrappers.

5. The method of claim 1 wherein the at least one software wrapper used to generate the second aggregate data representation also is used to generate first aggregate data representation.

6. The method of claim 1 wherein the at least at least one software wrapper used to generate the second aggregate data representation is different from the one or more software wrappers used to generate first aggregate data representation.

7. The method of claim 1 wherein the second aggregate data representation is generated using the first aggregate data representation from the first software accumulator and data from at least a third software accumulator.

8. The method of claim 1 further comprising interconnecting any arbitrary number of software accumulators to generate a corresponding number of aggregate data representations.

9. The method of claim 1 further comprising using aggregate data representations as building blocks to generate additional aggregate data representations as desired.

10. The method of claim 1 further comprising generating a universal data representation by normalizing the first or the second aggregate data representations.

11. The method of claim 1 further comprising caching information from one or more data sources.

12. The method of claim 11 wherein the information caching occurs at a software wrapper level or a software accumulator level or both.

13. A method of managing access to a data source, the method comprising:
encapsulating a data source in a software wrapper configured to accommodate one or more parameters of the data source and to provide an object representation of data in the data source;
detecting that one or more parameters of the data source have changed; and
automatically downloading from a remote source a replacement software wrapper configured to accommodate the changed one or more parameters of the data source.

14. The method of claim 13 further comprising installing the replacement software wrapper while the original software wrapper is executing.

15. The method of claim 13 wherein the one or more parameters of the data source relate to one or more of a format or a location of data in data source.

16. The method of claim 13 wherein the remote source comprises a self-healing manager component executing on a remote platform.

17. The method of claim 16 wherein the self-healing manager performs operations comprising:
determining whether a replacement software wrapper exists; and
if so, providing the replacement software wrapper to a requesting entity; and
if not, notifying a support site that a replacement software wrapper has been requested.

18. The method of claim 13 wherein detecting that one or more parameters of the data source have changed comprises identifying a change in the data that the software wrapper is unable to accommodate.

19. The method of claim 13 wherein automatically downloading a replacement software wrapper from a remote source comprises sending an error manager to a remote self-healing manager component.

20. The method of claim 13 further comprising, upon detecting that one or more parameters of the data source have changed, ceasing to provide data from the software wrapper.

21. The method of claim 20 further comprising:
installing the automatically downloaded software wrapper; and
resuming to provide data from the software wrapper without having to restart an application associated with the software data wrapper.

22. The method of claim 13 wherein automatically downloading a replacement software wrapper from a remote source comprises periodically polling a remote process until a replacement software wrapper is available.

23. A method of managing access to a data source, the method comprising:
encapsulating each of a plurality of data sources in an associated software wrapper configured to provide an object representation of data from the data source;
providing outputs of the software wrappers to a software accumulator that aggregates data to generate an aggregate data representation;
detecting that one or more data parameters have changed; and
automatically downloading from a remote source a replacement software accumulator configured to accommodate the changed one or more data parameters.

24. The method of claim 23 further comprising automatically downloading from a remote source a replacement software wrapper configured to accommodate the changed one or more data parameters.

25. The method of claim 23 further comprising installing the replacement software accumulator while the original software accumulator is executing.

26. The method of claim 23 wherein the one or more data parameters relate to one or more of a format or a location of data in data source.

27. The method of claim 23 wherein the remote source comprises a self-healing manager component executing on a remote platform.

28. The method of claim 23 wherein the self-healing manager performs operations comprising:
determining whether a replacement software accumulator exists; and
if so, providing the replacement software accumulator to a requesting entity; and
if not, notifying a support site that a replacement software accumulator has been requested.

29. The method of claim 23 further comprising, upon detecting that one or more data parameters have changed, ceasing to provide data from the software accumulator.

30. The method of claim 29 further comprising:
installing the automatically downloaded software accumulator; and
resuming to provide data from the software accumulator.

31. The method of claim 23 wherein automatically downloading a replacement software accumulator from a remote source comprises periodically polling a remote process until a replacement software accumulator is available.

32. A distributed data processing system comprising:
an interface configured to receive a data processing request from a requesting entity;
a processing server configured to provide access to one or more local data processing applications;
one or more shadow processing servers, each shadow processing server configured to provide access to one or more remote data processing applications; and
an application server, in communication with the processing server and the shadow processing server, and configured to fulfill the received data processing request by selectively accessing local and remote data processing applications in a manner that is transparent to the requesting entity.

33. The system of claim 32 wherein the interface configured to receive a data processing request from a requesting entity comprises a web server.

34. The system of claim 32 wherein each shadow processing server has a communications link for communicating with an interface at a remote data processing system.

35. The system of claim 34 wherein the shadow processing server communicates with a servlet executing in a web server at the remote data processing system.

36. The system of claim 32 wherein each shadow processing server has an associated configuration file that identifies one or more remote data processing applications.

37. A distributed data acquisition system comprising:
an interface configured to receive a data acquisition request from a requesting entity;
an information server configured to provide access to one or more local data sources;
one or more shadow information servers, each shadow information server configured to provide access to one or more remote data sources; and
an application server, in communication with the information server and the shadow information server, and configured to fulfill the received data acquisition request by selectively accessing local and remote data sources in a manner that is transparent to the requesting entity.

38. The system of claim 37 wherein the interface configured to receive a data acquisition request from a requesting entity comprises a web server.

39. The system of claim 37 wherein each shadow information server has a communications link for communicating with an interface at a remote data processing system.

40. The system of claim 39 wherein the shadow information server communicates with a servlet executing in a web server at the remote data acquisition system.

41. The system of claim 37 wherein each shadow information server has an associated configuration file that identifies one or more remote data source.

42. A distributed data acquisition and processing system comprising:
an interface configured to receive an information request from a requesting entity;
a processing server configured to provide access to one or more local data processing applications;
one or more shadow processing servers, each shadow processing server configured to provide access to one or more remote data processing applications;
an information server configured to provide access to one or more local data sources;
one or more shadow information servers, each shadow information server configured to provide access to one or more remote data sources; and
an application server, in communication with the processing server, the shadow processing server, the information server, and the shadow information server, and configured to fulfill the received information request by selectively accessing local and remote data sources and local and remote data processing applications in a manner that is transparent to the requesting entity.

43. A method for managing heterogeneous data sources, the method comprising:
a) querying a plurality of heterogeneous data sources, each data source having an associated software wrapper configured to (i) create an object representation of the data, (ii) transform a language of the query into a native language of the data source, (iii) construct a database for caching information contained in the data source, (iv) cache the information contained in the data source in the database automatically; (v) perform self-tests to ensure the wrapper is operating correctly, (vi) provide notification upon detecting an error, and (vii) download and install updates automatically when an error is detected;
b) creating an object representation of each queried data source;
c) normalizing data in the object representations to provide a semantically consistent view of the data in the queried data sources; and
d) aggregating the object representations into a universal data representation.

44. The method of claim 43 wherein normalizing data comprises performing data normalization or vocabulary normalization or both.

45. The method of claim 43 further comprising removing duplicate data.

46. The method of claim 43 further comprising verifying an update's authenticity prior to installation.

47. The method of claim 43 wherein querying the plurality of data sources comprises submitting a query to a data integration engine that distributes the query to the plurality of data sources.
